(19) United States
(12) Patent Application Publication
(10) Pub. No.: US 2020/0295412 A1
(43) Pub. Date: Sep. 17, 2020

(54) PROTECTION DEVICE AND METHOD FOR SUPERCAPACITOR OF POWER SUPPLY SYSTEM OF VEHICLE

(71) Applicant: FU-CHIEH CHEN, TAICHUNG (TW)

(72) Inventor: FU-CHIEH CHEN, TAICHUNG (TW)

(21) Appl. No.: 16/812,377

(22) Filed: Mar. 9, 2020

(30) Foreign Application Priority Data
Mar. 16, 2019 (TW) 108109203

(51) Int. Cl. H01M 10/42; H02J 7/00; H02J 7/34; B60L 50/64; B60L 50/40

(52) U.S. Cl. CPC H01M 10/4264; H01M 10/4257; H02J 7/00302; H01M 2220/20; B60L 50/64; B60L 50/40; H02J 7/345

(57) ABSTRACT

A protection device for a supercapacitor of a power supply system of vehicle, the power supply system including a rechargeable battery, the supercapacitor, and a power generator. The protection device contains a first voltage detector, a second voltage detector, a temperature detector, a processing unit, a control unit, a communication unit, and an alarm. The first voltage detector is coupled with the rechargeable battery to detect and send a voltage value of the rechargeable battery to the processing unit. The second voltage detector is coupled with the supercapacitor to detect and send a voltage value of the supercapacitor to the processing unit. The temperature detector is coupled with the supercapacitor to detect and send a temperature value of the supercapacitor to the processing unit. The control unit includes a first transistor and a second transistor which are connected in series, and the first transistor and the second transistor are Metal-Oxide-Semiconductor Field-Effect Transistor (MOSFET).

### FIELD OF THE INVENTION

The present invention relates to a power supply system of vehicle having a supercapacitor, and more particularly to a protection device and method for the supercapacitor of the power supply system of the vehicle, wherein the protection method is executed by the protection device.

### BACKGROUND OF THE INVENTION

A start-stop system is applied to reduce fuel consumption, exhaust emission, and control stopping and starting of an engine of vehicle. For example, when the vehicle stalls idly, the engine stops automatically. When the vehicle starts after stalling, the engine operates automatically. When the vehicle stops at a red light, the engine stalls automatically, thus reducing the fuel consumption and the exhaust emission.

After starting the engine of the vehicle, currents are outputted to the batteries so that the motor drives the engine to operate, and the engine actuates a power generator to produce electric energy, and the electric energy store in the batteries. Conventionally, the batteries are lead-acid batteries, and lithium batteries are used as rechargeable batteries at present. When the vehicle has the start-stop system, the engine stalls and starts repeatedly by using the start-stop system when the vehicles are running, such that the batteries outputs currents to drive the motor to run, but a service life of the batteries reduces quickly.

Due to climate changes, the ambient temperature in winter in European and American countries is often below −10° C. Thus, it is difficult to start the vehicle (such as gasoline/diesel cars or motorcycles) in a low temperature by ways of conventional batteries.

To overcome such problems, an improved power supply system of the vehicle has been developed, wherein the power supply system contains a rechargeable battery, a supercapacitor, and a power generator. The rechargeable battery is configured to charge and discharge and is a lead-acid battery or a lithium battery. The rechargeable battery is connected with the supercapacitor in parallel, wherein the rechargeable battery and the supercapacitor are configured to start a motor for driving the engine and the electrical equipment (such as a mobile computer, audio equipment, and an air conditioner) of the vehicle. The power generator is coupled with the rechargeable battery and the supercapacitor, and the power generator is driven by the engine to operate and to supply the power to the rechargeable battery and supercapacitor. In addition, the rechargeable battery supplies the power to the supercapacitor.

The power supply system supplies electric energy to the motor by using the supercapacitor, hence the supercapacitor has high power density, short charge and discharge time, long service life, and wide working range so as to drive the motor to operate in high torque and large currents. The supercapacitor is charged in a short time after discharging to enhance operation of the engine after the vehicle stalls. It solves the problem of using lead-acid batteries or secondary lithium batteries as the power for starting the engine, and avoiding rapid loss of the service life of lead-acid batteries or secondary lithium batteries.

Preferably, the supercapacitor charges and discharges in a low temperature (such as within −40° C. to 70° C.) so as to supply the power to the motor, and the motor drives the engine to operate.

However, a withstand voltage value of the supercapacitor is limited, for example, when the voltage of the supercapacitor is more than the withstand voltage value, the supercapacitor is broken easily. Furthermore, when a temperature of the supercapacitor is extremely high, the supercapacitor is broken quickly. The charging of the supercapacitor affects the voltage and temperature of the supercapacitor. After the supercapacitor is damage, the voltage of the supercapacitor is measured manually.

The present invention has arisen to mitigate and/or obviate the afore-described disadvantages.

### SUMMARY OF THE INVENTION

The primary objective of the present invention is to provide a protection device for a supercapacitor of a power supply system of vehicle which is capable of avoiding being damaged by controlling discharging and charging of the supercapacitor.

Another primary objective of the present invention is to provide a protection method for a supercapacitor of a power supply system of vehicle which is executed by the protection device.

To obtain the above objectives, a protection device for a supercapacitor of a power supply system of vehicle provided by the present invention, the power supply system including a rechargeable battery, the supercapacitor, and a power generator.

The rechargeable battery is in connection with the supercapacitor n parallel, the power generator is coupled with the rechargeable battery and the supercapacitor, and the protection device is coupled with the rechargeable battery and the supercapacitor.

The protection device contains a first voltage detector, a second voltage detector, a temperature detector, a processing unit, a control unit, a communication unit, and an alarm. The first voltage detector, the second voltage detector, the temperature detector, the control unit, the communication unit, and the alarm are coupled with the processing unit. The first voltage detector is coupled with the rechargeable battery to detect and send a voltage value of the rechargeable battery to the processing unit. The second voltage detector is coupled with the supercapacitor to detect and send a voltage value of the supercapacitor to the processing unit. The temperature detector is coupled with the supercapacitor to detect and send a temperature value of the supercapacitor to the processing unit. The processing unit is a microprocessor and is configured to send a control signal to the control unit based on the voltage value and the temperature value of the supercapacitor so that the control unit controls a charging and a discharging of the supercapacitor. The communication unit is a Bluetooth communicator and is configured to send and receive a Bluetooth signal, and the processing unit sends the Bluetooth signal to an external communication device via the communication unit, and the alarm is a light-emitting diode (LED) warning lamp.

The control unit includes a first transistor and a second transistor which are connected in series, and a back surface of the first transistor contacts with a back surface of the second transistor. In addition, the first transistor and the second transistor are Metal-Oxide-Semiconductor Field-Effect Transistor (MOSFET).

The protection device further contains a battery judging unit, and the battery judging unit is coupled with the processing unit and is configured to detect and judge a type and a specification of the rechargeable battery. The battery judging unit sends a judged signal to the processing unit so as to set a relaxation voltage of the rechargeable battery.

A protection method executed by the protection device contains steps of:

1) pre-checking the supercapacitor, wherein the control unit is in a completely off mode, and the processing unit judges whether the supercapacitor is normal based on a flag of the supercapacitor;

wherein when the supercapacitor is abnormal, the control unit is in the completely off mode, and the alarm emits warning lights; when the supercapacitor is normal, a power capacity of the supercapacitor is tested;

2) testing the power capacity of the supercapacitor, wherein the voltage value of the supercapacitor is compared with a first safe voltage value; when the voltage value of the supercapacitor is less than the first safe voltage value, the voltage value of the supercapacitor is detected and is compared with the first safe voltage value successively; when the voltage value of the supercapacitor is equal to or is more than the first safe voltage value, a voltage balance is executed;

3) producing the voltage balance, wherein the control unit is in a complete on mode, and the rechargeable battery and the supercapacitor charge and discharge to each other so as to produce the voltage balance;

4) judging whether an engine is running, wherein the voltage value of the rechargeable battery is compared with the relaxation voltage of the rechargeable battery;

wherein when the voltage value of the rechargeable battery is more than the relation voltage, the engine is running to execute an overcharge protection; when the voltage value of the rechargeable battery is less than the relation voltage, the engine stops to execute a second over-temperature protection;

5) executing the overcharge protection, wherein when the voltage value of the supercapacitor is more than a second safe voltage value, the control unit is in a complete discharging mode, and the voltage value of the supercapacitor is compared with the second safe voltage value continuously; when the voltage value of the supercapacitor is equal to or is less than the second safe voltage value, the control unit is in the completely on mode, and a first over-temperature protection is executed;

6) executing the first over-temperature protection, wherein when the temperature value of the supercapacitor is more than a safe temperature value, the control unit is in the complete discharging mode, the temperature value of the supercapacitor is compared with the safe temperature value; when the temperature value of the supercapacitor is equal to or is less than the safe temperature value, the control unit is in the completely on mode, and the voltage balance is executed;

7) executing the second over-temperature protection, wherein when the temperature value of the supercapacitor is more than the safe temperature value, the control unit is in the complete discharging mode, the temperature value of the supercapacitor is compared with the safe temperature value successively; when the temperature value of the supercapacitor is equal to or is less than the safe temperature value, the control unit is in the completely on mode;

8) determining whether executing the capacitance test, wherein when the second over-temperature protection is executed, and the control unit is in the completely on mode, the processing unit starts a timer and detects whether the engine is running;

wherein when the engine stops for a period of predetermined starting time, the capacitance test is executed;

wherein when a stopping time of the engine is less than the starting time, the voltage balance is executed;

9) executing the capacitance test, wherein the voltage value of the rechargeable battery is compared with the voltage value of the supercapacitor after the control unit is in the completely off mode for 5 seconds, and a difference between the voltage value of the rechargeable battery and the voltage value of the supercapacitor is a voltage difference value;

wherein when the voltage difference value is less than or is equal to 0.5 V, the control unit is in the completely on mode so as to stop the capacitance test and to execute the voltage balance;

wherein when the voltage difference value is more than 0.5 V, the processing unit records abnormal conditions, and a time of the abnormal conditions is accumulated and is compared with a predetermined warning time;

wherein when the time of the abnormal conditions is less than or is equal to the predetermined warning time, the control unit is in the completely on mode after the processing unit starts the timer for 10 seconds so as to stop the capacitance test and to execute the voltage balance; and

wherein when the time of the abnormal conditions is more than the predetermined warning time, the processing unit records the flag of the supercapacitor is abnormal, the control unit is in the completely off mode continuously, and the alarm emits the warning lights.

When the engine stops, the control signal is sent to the communication unit by ways of the external communication device to execute the capacitance test.

Preferably, when the protection device executes the overcharge protection, the first over-temperature protection, and the second over-temperature protection, raising of the voltage value and the temperature value and of the supercapacitor is avoidable so as to avoid a damage of the supercapacitor, when the voltage value and the temperature value of the supercapacitor are extremely high. When the power capacity of the supercapacitor decreases, the alarm emits the warning lights so that the user replaces the supercapacitor immediately.

### BRIEF DESCRIPTION OF THE DRAWINGS

FIG. 1 is a circuit block diagram showing the application of a protection device for a power supply system of vehicle according to a preferred embodiment of the present invention,

FIG. 2 is a circuit block diagram of the protection device for the power supply system of the vehicle according to the preferred embodiment of the present invention,

FIG. 3 is a flow chart showing a protection method being executed by the protection device for the power supply system of the vehicle according to the preferred embodiment of the present invention,

FIG. 4 is a flow chart of an overcharge protection and a first over-temperature protection of FIG. 3 according to the preferred embodiment of the present invention,

FIG. 5 is a flow chart of a second over-temperature protection of FIG. 3 according to the preferred embodiment of the present invention, and

FIG. 6 is a flow chart of a capacitance test of FIG. 3 according to the preferred embodiment of the present invention.

### DETAILED DESCRIPTION OF THE PREFERRED EMBODIMENTS

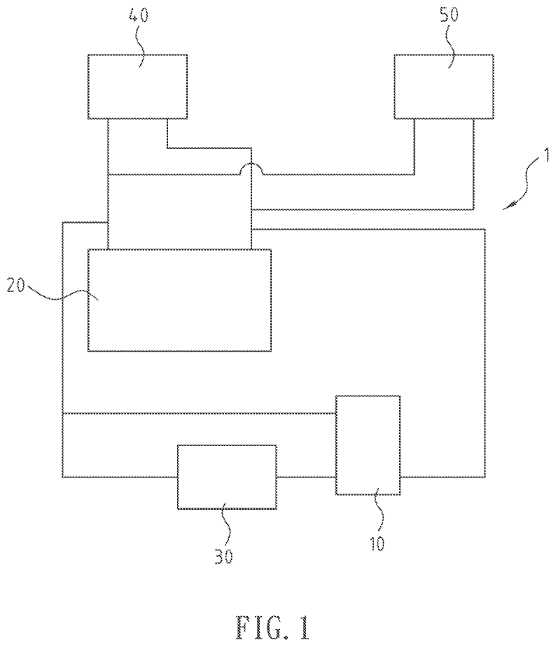

With reference to FIG. 1, a protection device 10 for a supercapacitor according to a preferred embodiment of the present invention is mounted on a power supply system 1 of vehicle, and the power supply system 1 includes a rechargeable battery 20, the supercapacitor 30, and a power generator 40. The rechargeable battery 20 is a rechargeable lead-acid battery or a rechargeable lithium battery, and the rechargeable battery 20 is in connection with the supercapacitor 30 in parallel so that the rechargeable battery 20 and the supercapacitor 30 supply power to a motor and electrical equipment 50 (such as a mobile computer, audio equipment, and an air conditioner) of the vehicle. The power generator 40 is coupled with the rechargeable battery 20 and the supercapacitor 30 and is applied to supply power to the rechargeable battery 20 and the supercapacitor 30, wherein the rechargeable battery 20 is configured to supply the power to the supercapacitor 30. The protection device 10 is located in a charging path of the supercapacitor 30 and is electrically connected with a negative electrode of the rechargeable battery 20 and a negative electrode of the supercapacitor 30 so as to control power charging and discharging of the supercapacitor 30. The protection device 10 is electrically connected with a positive electrode of the rechargeable battery 20 so as to detect a voltage value of the rechargeable battery 20, thus distinguishing starting or stopping of an engine of the vehicle.

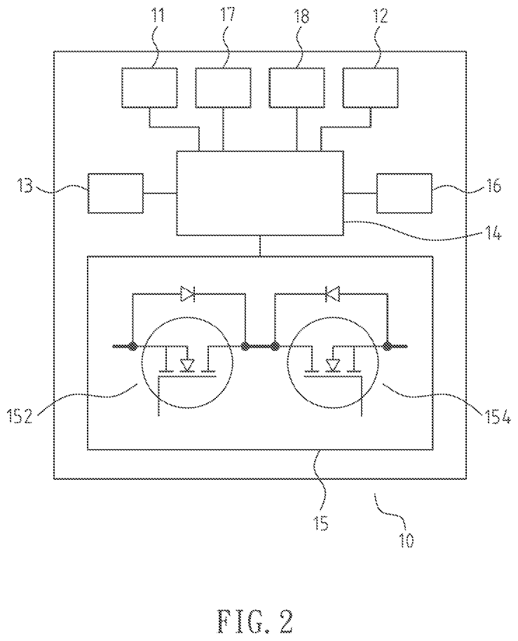

Referring to FIG. 2, the protection device 10 of the present invention comprises a first voltage detector 11, a second voltage detector 12, a temperature detector 13, a processing unit 14, a control unit 15, a communication unit 16, a battery judging unit 17, and an alarm 18, wherein the first voltage detector 11, the second voltage detector 12, the temperature detector 13, the control unit 15, the communication unit 16, the battery judging unit 17, and the alarm 18 are coupled with the processing unit 14. The first voltage detector 11 and the battery judging unit 17 are coupled with the rechargeable battery 20, the first voltage detector 11 is configured to detect and send the voltage value of the rechargeable battery 20 to the processing unit 14. The battery judging unit 17 is configured to detect and judge a type and a specification of the rechargeable battery 20 (such as the lead-acid battery or the rechargeable lithium battery), and the battery judging unit 17 sends a judged signal to the processing unit 14 so as to set a relaxation voltage of the rechargeable battery 20. The second voltage detector 12 is coupled with the supercapacitor 30 to detect and send a voltage value of the supercapacitor 30 to the processing unit 14. The temperature detector 12 is coupled with the supercapacitor 30 to detect and send a temperature value of the supercapacitor 30 to the processing unit 14, wherein the processing unit 14 is a microprocessor and is configured to send a control signal to the control unit 15 based on the voltage value and the temperature value of the supercapacitor 30 so that the control unit 15 controls a circuit on/off between the negative electrode of the rechargeable battery 20 and the negative electrode of the supercapacitor 30, thus controlling the charging and the discharging of the supercapacitor 30. The communication unit 16 is a Bluetooth communicator and is configured to send and receive a Bluetooth signal, wherein the processing unit 14 sends the Bluetooth signal to an external communication device (not shown) via the communication unit 16 so that a user operates the protection device, wherein the external communication device is a handheld communication device or other communication devices, and the external communication device includes an application program for controlling the protection device, and the alarm 18 is a light-emitting diode (LED) warning lamp.

The control unit 15 includes a first transistor 152 and a second transistor 154 which are connected in series, and a back surface of the first transistor 152 contacts with a back surface of the second transistor 154, wherein the first transistor 152 and the second transistor 154 are Metal-Oxide-Semiconductor Field-Effect Transistor (MOSFET), and a source of the first transistor 152 is electrically connected with the rechargeable battery 20, wherein a source of the second transistor 154 is electrically connected with the supercapacitor 30, and a drain of the first transistor 152 is electrically connected with a drain of the second transistor 154, such that the control unit 15 controls the supercapacitor 30 to not charge and discharge or to charge and discharge.

When the first transistor 152 and the second transistor 154 are electrically conductive in a unidirectional power path (i.e. in a completely off mode), the supercapacitor 30 does not discharge and receives the power. When the first transistor 152 and the second transistor 154 are electrically conductive in a two-way power path (i.e. in a completely on mode), the supercapacitor 30 discharges and receives the power. When the first transistor 152 is electrically conductive in the two-way power path and the second transistor 154 is in the unidirectional power path (in other words, the first transistor 152 and the second transistor 154 are in a discharging mode), the supercapacitor 30 discharges and does not receive the power.

As shown in FIGS. 1-3, a protection method for the supercapacitor of the present invention is executed by the protection device 30 and comprises steps of:

1) pre-checking the supercapacitor, wherein the control unit 15 is in the completely off mode so that the supercapacitor 30 does not charge and discharge, and the processing unit 14 judges whether the supercapacitor 30 is normal based on a flag of the supercapacitor 30, wherein the flag of the supercapacitor 30 is configured to execute a capacitance test as following description;

wherein when the supercapacitor 30 is abnormal, the processing unit 14 sends the control signal to the control unit 15 and the alarm 18 so as to execute a capacitive lock of the supercapacitor 30, and the control unit 15 is in the completely off mode so that the supercapacitor 30 does not charge and discharge, and the alarm 18 emits warning lights so that the supercapacitor 30 is maintained or is replaced;

wherein when the supercapacitor 30 is normal, a power capacity of the supercapacitor 30 is tested; 2) testing the power capacity of the supercapacitor 30, wherein the processing unit 14 compares the voltage value of the supercapacitor 30 detected by the second voltage detector 11 with a first safe voltage value; when the voltage value of the supercapacitor 30 is less than the first safe voltage value, the voltage value of the supercapacitor 30 is detected and is compared with the first safe voltage value successively, when the voltage value of the supercapacitor 30 is equal to or is more than the first safe voltage value, the processing unit 14 sets the relaxation voltage and executes a voltage balance based on the type and the specification of the rechargeable battery (such as the lead-acid battery or the rechargeable lithium battery);

wherein the first safe voltage is determined according to a withstand current of each of the first transistor 152 and the second transistor 154 and a voltage difference between the rechargeable battery 20 and the supercapacitor 30;

3) sending the control signal from the processing unit 14 to the control unit 15, wherein the control unit 15 is in the completely on mode so that the rechargeable battery 20 and the supercapacitor 30 charge and discharge to each other so as to produce the voltage balance between the rechargeable battery 20 and the supercapacitor 30;

4) judging whether an engine is running, wherein after the voltage balance produces between the rechargeable battery 20 and the supercapacitor 30, the processing unit 14 compares the voltage value of the rechargeable battery 20 detected by the first voltage detector 11 with the relaxation voltage;

wherein when the voltage value of the rechargeable battery 20 is more than the relation voltage, the engine is running to execute an overcharge protection; when the voltage value of the rechargeable battery 20 is less than the relation voltage, the engine stops to execute a second over-temperature protection;

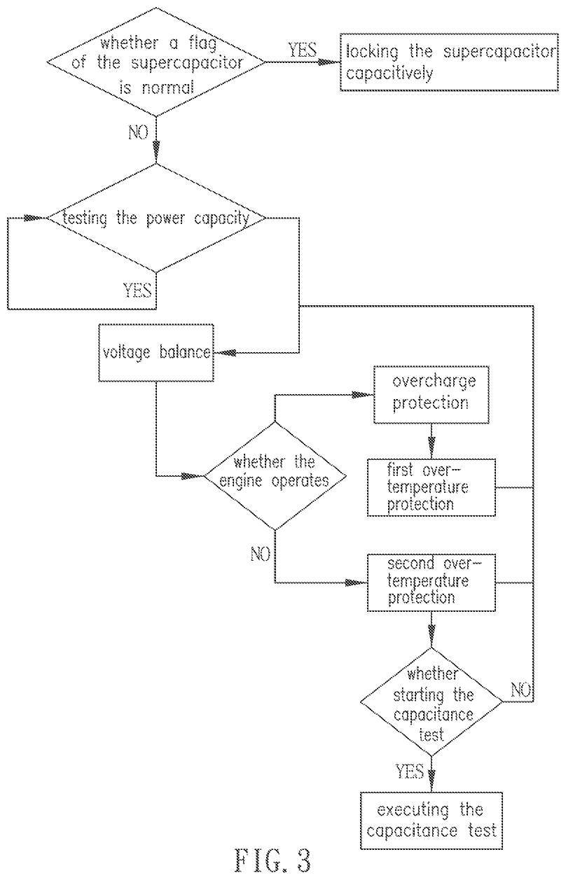

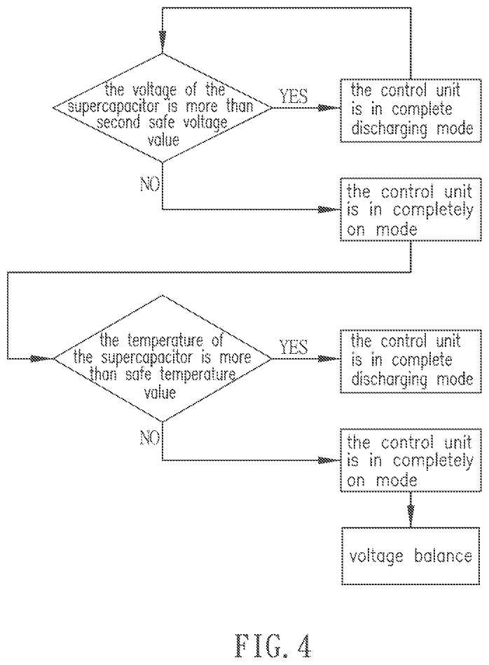

5) executing the overcharge protection, as illustrated in FIGS. 3 and 4, when the voltage value of the supercapacitor 30 is more than a second safe voltage value, the processing unit 14 sends the control signal to the control unit 15 so that the control unit 15 is in a complete discharging mode, wherein the supercapacitor 30 discharges and does not receive the power so as to avoid a damage of the supercapacitor 30, when the voltage value of the supercapacitor 30 is more than a withstand voltage value of a capacitance, the voltage value of the supercapacitor 30 is compared with the second safe voltage value;

when the voltage value of the supercapacitor 30 is equal to or is less than the second safe voltage value, the control unit 15 is in the completely on mode, the supercapacitor 30 charges and discharges, and a first over-temperature protection is executed, wherein the second safe voltage value is determined based on the specification of the supercapacitor 30, and when the vehicle is a small car, a power supply system of the small car has the supercapacitor 30, and a safe voltage value of the supercapacitor 14.2 V;

6) executing the first over-temperature protection, as shown in FIGS. 3-4, wherein when the temperature value of the supercapacitor 30 is more than a safe temperature value, the processing unit 14 sends the control signal to the control unit 15, and the control unit 15 is in the complete discharging mode, wherein the supercapacitor 30 discharges and does not receive the power so as to avoid a damage of the supercapacitor 30, and the temperature value of the supercapacitor 30 is compared with the safe temperature value, when the temperature of the supercapacitor 30 is extremely high;

when the temperature value of the supercapacitor 30 is equal to or is less than the safe temperature value, the processing unit 14 sends the control signal to the control unit 15, wherein the control unit 15 is in the completely on mode, and the supercapacitor 30 discharges and charges so as to execute the voltage balance;

wherein the safe temperature value is determined according to the specification of the supercapacitor 30, the vehicle is the small car, and the safe temperature value of the supercapacitor of the power supply system of the small car is 55° C.;

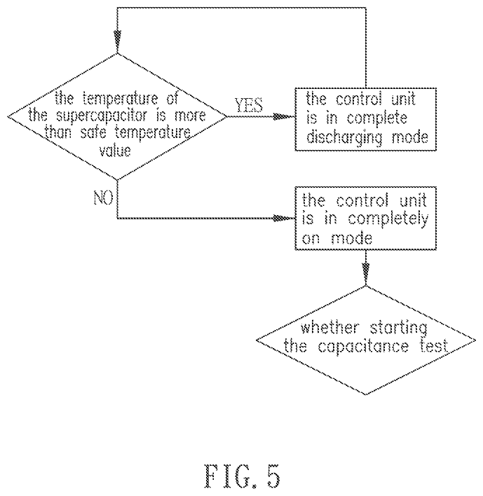

7) executing the second over-temperature protection, as illustrated in FIGS. 3-5, wherein when the engine stops and the temperature value of the supercapacitor 30 is more than the safe temperature value, the processing unit 14 sends the control signal to the control unit 15, the control unit 15 is in the complete discharging mode, and the supercapacitor 30 discharges and does not receive the power so as to avoid the damage of the supercapacitor 30, and the temperature value of the supercapacitor 30 is compared with the safe temperature value when the temperature of the supercapacitor 30 is extremely high;

wherein when the temperature value of the supercapacitor 30 is equal to or is less than the safe temperature value, the processing unit 14 sends the control signal to the control unit 15, the control unit 15 is in the completely on mode, and the supercapacitor 30 charges and discharges;

8) determining whether executing the capacitance test, wherein when the temperature of the supercapacitor 30 is less than or is equal to the safe temperature value, the control unit 15 is in the completely on mode, and the processing unit 14 starts a timer and detects whether the engine is running;

wherein when the engine stops for a period of predetermined starting time, the capacitance test is executed, wherein the starting time is two hours or is more than or is less than two hours;

wherein when a stopping time of the engine is less than the starting time, the voltage balance is executed;

wherein when the engine stops, the user sends the control signal to the communication unit 16 by ways of the external communication device (not shown) which includes the application program for controlling the protection device 10, the communication device 16 sends the control signal to the processing unit 14 to execute the capacitance test, wherein the stopping time of the engine is not limited by the starting time;

9) executing the capacitance test, wherein in the capacitance test, the power capacity of the supercapacitor 30 is tested as follows:

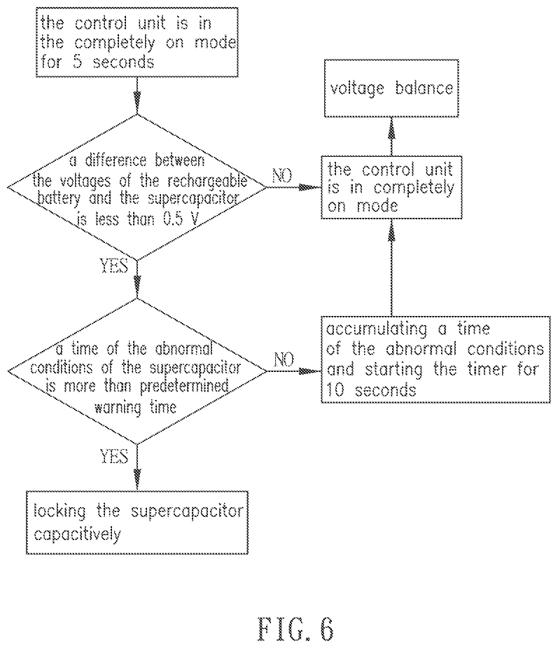

as shown in FIGS. 3-6, the processing unit 14 sends the control signal to the control unit 15 so that the voltage value of the rechargeable battery 20 is detected and compared with the voltage value of the supercapacitor 30 after the control unit 15 is in the completely off mode for 5 seconds, wherein a difference between the voltage value of the rechargeable battery 20 and the voltage value of the supercapacitor 30 is a voltage difference value;

when the voltage difference value is less than or is equal to 0.5 V, the processing unit 14 sends the control signal to the control unit 15, and the control unit 15 is in the completely on mode so as to stop the capacitance test and to execute the voltage balance;

when the voltage difference value is more than 0.5 V, the processing unit 14 records abnormal conditions, and a time of the abnormal conditions is accumulated and is compared with a predetermined warning time, wherein the predetermined warning time is 5;

wherein when the time of the abnormal conditions is less than or is equal to the predetermined warning time, the control unit 15 is in the completely on mode after the processing unit 14 starts the timer for 10 seconds so as to stop the capacitance test and to execute the voltage balance;

wherein when the time of the abnormal conditions is more than the predetermined warning time, the processing unit 14 records the flag of the supercapacitor 30 is abnormal and sends the control signal to the control unit 15 and the alarm 18 so as to execute the capacitive lock of the supercapacitor 30, and the control unit 15 is in the completely off mode continuously, wherein the supercapacitor 30 is locked capacitively to not charge or discharge, and the alarm 18 emits the warning lights so that the supercapacitor 30 is maintained and replaced.

Thereby, when the protection method is executed by using the protection device 10, the overcharge protection, the first over-temperature protection, and the second over-temperature protection are executed, wherein when the voltage value of the supercapacitor 30 is more than the second safe voltage value, the control unit 15 controls the supercapacitor 30 to discharge and not charge, thus avoiding increasing of the voltage value of the supercapacitor 30. Preferably, when the supercapacitor 30 discharges, the voltage value of the supercapacitor 30 is decreased. When the temperature value of the supercapacitor 30 is more than the safe temperature value, the control unit 15 controls the supercapacitor 30 to discharge and not charge so as to avoid a raising of the temperature value of the supercapacitor 30 and to decrease the temperature value of the supercapacitor 30. Accordingly, the protection device 10 protects the supercapacitor 30 effectively to avoid the damage of the supercapacitor 30 when the voltage and the temperature of the supercapacitor 30 are extremely high. When the power capacity of the supercapacitor 30 decreases, the alarm emits the warning lights so that the user replaces the supercapacitor 30.

The battery judging unit 17 is selectively provided on or is not provided on the protection device 10. For example, when the battery judging unit 17 is not provided on the protection device 10 and the protection device 10 executes the protection method, the relaxation voltage of the rechargeable battery 20 is set by the processing unit 14, and the rechargeable battery 20 or the protection device 10 is fixed based on the type and the specification of the rechargeable battery 20.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A protection device for a supercapacitor of a power supply system of vehicle, the power supply system including a rechargeable battery, the supercapacitor, and a power generator, the rechargeable battery being in connection with the supercapacitor in parallel, the power generator being coupled with the rechargeable battery and the supercapacitor, and the protection device being coupled with the rechargeable battery and the supercapacitor;
the protection device comprises a first voltage detector, a second voltage detector, a temperature detector, a processing unit, a control unit, a communication unit, and an alarm, wherein the first voltage detector, the second voltage detector, the temperature detector, the control unit, the communication unit, and the alarm are coupled with the processing unit, wherein the first voltage detector is coupled with the rechargeable battery to detect and send a voltage value of the rechargeable battery to the processing unit, the second voltage detector is coupled with the supercapacitor to detect and send a voltage value of the supercapacitor to the processing unit, wherein the temperature detector is coupled with the supercapacitor to detect and send a temperature value of the supercapacitor to the processing unit, wherein the processing unit is a microprocessor and is configured to send a control signal to the control unit based on the voltage value and the temperature value of the supercapacitor so that the control unit controls a charging and a discharging of the supercapacitor, wherein the communication unit is a Bluetooth communicator and is configured to send and receive a Bluetooth signal, and the processing unit sends the Bluetooth signal to an external communication device via the communication unit, wherein and the alarm is a light-emitting diode (LED) warning lamp;
wherein the control unit includes a first transistor and a second transistor which are connected in series, and a back surface of the first transistor contacts with a back surface of the second transistor, wherein the first transistor and the second transistor are Metal-Oxide-Semiconductor Field-Effect Transistor (MOSFET).

2. The protection device as claimed in claim 1 further comprising a battery judging unit, the battery judging unit is coupled with the processing unit, and the battery judging unit is configured to detect and judge a type and a specification of the rechargeable battery, and the battery judging unit sends a judged signal to the processing unit so as to set a relaxation voltage of the rechargeable battery.

3. A protection method executed by the protection device as claimed in claim 1 comprising steps of:
1) pre-checking the supercapacitor wherein the control unit is in a completely off mode, and the processing unit judges whether the supercapacitor is normal based on a flag of the supercapacitor;
wherein when the supercapacitor is abnormal, the control unit is in the completely off mode, and the alarm emits warning lights; when the supercapacitor is normal, a power capacity of the supercapacitor is tested;
2) testing the power capacity of the supercapacitor, wherein the voltage value of the supercapacitor is compared with a first safe voltage value; when the voltage value of the supercapacitor is less than the first safe voltage value, the voltage value of the supercapacitor is detected and is compared with the first safe voltage value successively; when the voltage value of the supercapacitor is equal to or is more than the first safe voltage value, a voltage balance is executed;
3) producing the voltage balance, wherein the control unit is in a complete on mode, and the rechargeable battery and the supercapacitor charge and discharge to each other, so as to produce the voltage balance;
4) judging whether an engine is running, wherein the voltage value of the rechargeable battery is compared with the relaxation voltage of the rechargeable battery;
wherein when the voltage value of the rechargeable battery is more than the relation voltage, the engine is running to execute an overcharge protection; when the voltage value of the rechargeable battery is less than the relation voltage, the engine stops to execute a second over-temperature protection;
5) executing the overcharge protection, wherein when the voltage value of the supercapacitor is more than a second safe voltage value, the control unit is in a complete discharging mode, and the voltage value of the supercapacitor is compared with the second safe voltage value continuously; when the voltage value of the supercapacitor is equal to or is less than the second safe voltage value, the control unit is in the completely on mode, and a first over-temperature protection is executed;
6) executing the first over-temperature protection, wherein when the temperature value of the supercapacitor is more than a safe temperature value, the control unit is in the complete discharging mode, the temperature value of the supercapacitor is compared with the safe temperature value; when the temperature value of the supercapacitor is equal to or is less than the safe temperature value, the control unit is in the completely on mode, and the voltage balance is executed;
7) executing the second over-temperature protection, wherein when the temperature value of the supercapacitor is more than the safe temperature value, the control unit is in the complete discharging mode, the temperature value of the supercapacitor is compared with the safe temperature value successively; when the temperature value of the supercapacitor is equal to or is less than the safe temperature value, the control unit is in the completely on mode;
8) determining whether executing the capacitance test, wherein when the temperature of the supercapacitor is less than or is equal to the safe temperature value, the control unit is in the completely on mode, and the processing unit starts a timer and detects whether the engine is running;
wherein when the engine stops for a period of predetermined starting time, the capacitance test is executed;
wherein when a stopping time of the engine is less than the starting time, the voltage balance is executed;
9) executing the capacitance test, wherein the voltage value of the rechargeable battery is compared with the voltage value of the supercapacitor after the control unit is in the completely off mode for 5 seconds, and a difference between the voltage value of the rechargeable battery and the voltage value of the supercapacitor is a voltage difference value;
wherein when the voltage difference value is less than or is equal to 0.5 V, the control unit is in the completely on mode so as to stop the capacitance test and to execute the voltage balance;
wherein when the voltage difference value is more than 0.5 V, the processing unit records abnormal conditions, and a time of the abnormal conditions is accumulated and is compared with a predetermined warning time;
wherein when the time of the abnormal conditions is less than or is equal to the predetermined warning time, the control unit is in the completely on mode after the processing unit starts the timer for 10 seconds so as to stop the capacitance test and to execute the voltage balance; and
wherein when the time of the abnormal conditions is more than the predetermined warning time, the processing unit records the flag of the supercapacitor is abnormal, the control unit is in the completely off mode continuously, and the alarm emits the warning lights.

4. The protection device as claimed in claim 3, when the engine stops, the control signal is sent to the communication unit by ways of the external communication device to execute the capacitance test.
